(19) United States
(12) Patent Application Publication
(10) Pub. No.: US 2014/0126604 A1
(43) Pub. Date: May 8, 2014

(54) CHARGING HOPPER SYSTEM AND METHOD OF FILLING

(71) Applicant: INTECO SPECIAL MELTING TECHNOLOGIES GMBH, (US)

(72) Inventor: Knut Rummler, Kehl (DE)

(73) Assignee: INTECO SPECIAL MELTING TECHNOLOGIES GMBH, Bruck an der Mur (AU)

(21) Appl. No.: 13/847,512

(22) Filed: Mar. 20, 2013

(30) Foreign Application Priority Data
Sep. 20, 2010 (DE) 102010045825.2

(51) Int. Cl. F27D 3/00; B65B 1/06

(52) U.S. Cl. CPC F27D 3/0027; B65B 1/06
USPC 373/81; 141/2

(57) ABSTRACT

In a charging hopper system of an electric arc furnace with a closure member which can be opened, a hopper-like containment with a discharge opening and at least one suction opening, the closure member closes the precharging chamber, the precharging chamber is separated from the hopper-like containment by a separating wall which can be opened and, in addition, a movable push shield is arranged in the precharging chamber for moving scrap metal from the precharging chamber into the hopper-like containment.

This is a Continuation-In-Part application of pending international patent application PCT/DE2011/001741 filed Sep. 20, 2011 and claiming the priority of German patent application 10 2010 045 825.2 filed Sep. 20, 2010.

### BACKGROUND OF THE INVENTION

The invention resides in a charging hopper system for an electro-arc furnace with a closure member that can be opened, a hopper-like containment with a discharge opening and at least one suction opening, and also in a method of filling the arc furnace.

DE 103 55 549 A1 discloses a similar system. However, in this system gases can be discharged to the ambient in an uncontrolled manner when a scrap material basket is unloaded.

It is the object of the present invention to essentially reduce the chances of environmental contamination during such a procedure.

This problem is solved by the features of the main claim. To this end, a closure is provided which closes a precharging chamber. This pre-charging chamber is separated from the hopper-like containment by a separating wall which can be opened. Furthermore, a movable push shield is arranged in the precharging chamber.

In order to fill the hopper-like containment with the push shield disposed in a rest position and the separating wall closed the closure member is opened. After the unloading of the scrap material into the pre-charging chamber the closure member is closed. Then after opening the separating wall the push shield moves the scrap material into the hopper-like containment.

Particulars of the invention will become more readily apparent from the following description of schematically shown exemplary embodiments.

### BRIEF DESCRIPTION OF THE DRAWINGS

FIG. 1 is a longitudinal cross-sectional view of an electric furnace with a charging system,

FIG. 2 shows a detail of the basket guide structure,

FIG. 3 shows a detail of the sealing arrangement,

FIG. 4 shows the precharging chamber,

FIG. 5 shows the loaded precharging chamber in cross-section,

FIG. 6 shows the charging hopper system with partially filled hopper-like containment,

FIG. 7 shows the charging hopper system during charging of the second scrap basket volume,

FIG. 8 shows the charging hopper system after the filling of the hopper-like containment with the second scrap basket volume,

FIG. 9 shows the return movement of the push basket

FIG. 10 shows the arrangement of FIG. 8 in cross-section,

FIG. 11 shows the push basket with hydraulic drive,

FIG. 12 shows a curve push shield,

FIG. 13 shows a push shield with rope drives,

FIG. 14 shows the push shield with rod drive,

FIG. 15 shows a pivotable separating wall, and

FIG. 16 shows a push shield with a large stroke.

### DESCRIPTION OF EXEMPLARY EMBODIMENTS

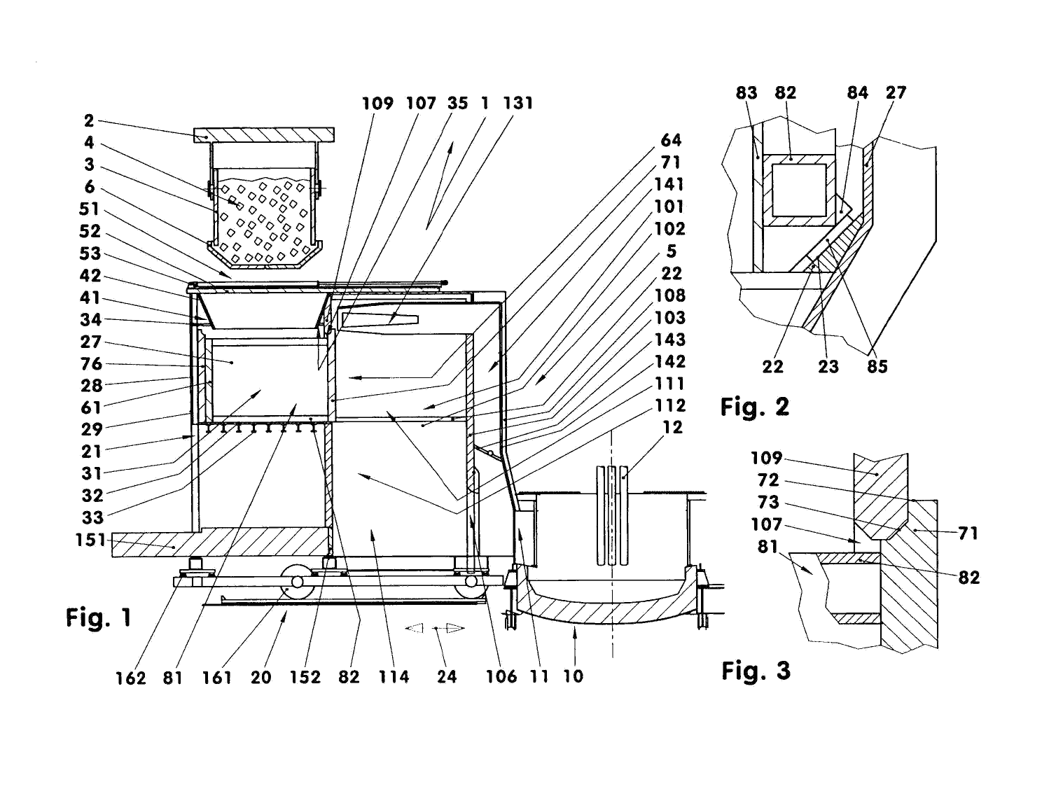

FIG. 1 shows an electric arc furnace 5 with a furnace containment 10 and with a charging system 20. By means of an electric arc furnace 5, a scrap material 4, for example steel scrap is melted by means of electric and/or fossil energy. After the melting and refining or respectively homogenizing, liquid steel is discharged from the furnace containment 10 at a temperature of for example 1620 degrees Celsius. With such a plant more than 100 tons per hour of liquid steel can be produced from steel scrap.

Since the density of the scrap material (4) is less than one tenth of the density of the liquid steel, for example, 7850 kilogram per cubic meter, the material volume required for a melt cannot all be introduced at once into the furnace containment 10 but rather in steps. For example, for a tapping of 100 tons of liquid steel, an input of more than 200 m³ scrap metal is required.

In the steel works, the metal scrap is first stored for example separately depending on various scrap metal types and qualities for example, light scrap, automotive scrap, mixed metal scrap, scrap metal mixed with plastic etc. . . . In each case, a scrap metal basket 3 is filled for example in a predetermined filling sequence. The loading volume of the scrap metal basket 3 is in the exemplary embodiment for example 75 m³.

The loaded scrap metal basket 3 is then transported by a transport arrangement 2 for example a building crane 2 to a charging hopper system 20.

The scrap metal 4 may also be transported from the scrap metal yard to the charging hopper system 20 by means of other continuous of discontinuous transport systems.

The charging hopper system 20 comprises a precharging chamber 31 with a closure member 51 and a hopper-like containment 101. The pre-charging chamber 31 and the hopper-like containment 101 are separated by a separating wall 71 which can be opened.

The pre-charging chamber 31 is in the exemplary embodiment a box-like chamber with a volume of for example 130 m³ and an at least approximately level bottom 32. The bottom may also be inclined downwardly toward the separating wall 71 for example at an inclination angle of up to 15 degrees. The bottom 32 is formed for example by metal sheets or planks with a thickness of for example 100 millimeters which are mounted on support beams 33 such as I-beams, hollow profile beams with square or rectangular cross-sections etc., which extend in a transverse direction 25. These beams 33 are connected to a water-cooled support frame 21 of the charging hopper system 20. The support frame 21 serves at the same time as a water distributor.

The side walls 26, 27 oriented in the longitudinal direction 24 of the charging hopper system 20 as well as the rear wall 28 are installed on the support frame 21. They may be removable for servicing purposes. The rear wall 28 is provided in the exemplary embodiment with a discharging opening 29. Also, the bottom 32 may include a discharge opening. For example, in the extension of the bottom 32 guide tracks are arranged in the side walls 26, 27, which are oriented in the longitudinal direction 24, see FIG. 2. They have guide surfaces 23 which extend at an angle or 45-60° with respect to a horizontal plane. They may be provided with an engagement structure for preventing their lift off.

The front wall of the pre-charging chamber 31 is formed in the representation of FIG. 1 by the separating wall 71. This separating wall 71 (see FIG. 3) consists for example of panel-shaped steel metal sheets and has for example at its top side 72 and at the side surfaces centering fases 73 for sealing the hopper-like containment 101, with respect to the pre-charging chamber 31. The separating wall 71 may be provided with reinforcement ribs. The surface area of the separating wall 71 is greater than the surface area of the push shield 61—both projected in a horizontal direction.

The top side 34 of the pre-charging chamber 31 has, for example, a rectangular opening 35. The cross-sectional area of the opening 35 may correspond to the area of the bottom 32 or it may be smaller.

In the embodiment as shown in FIG. 1, the top side 34 of the precharging chamber 31 is sealed to a funnel 41. The funnel 41 extends into the precharging chamber 31 so that at least the prism webs 22 are disposed below the funnel 41. Vertically dropping scrap material 4 can therefore not damage the webs 21 forming guide tracks 22.

In the exemplary embodiment, the wall surfaces of the funnel are not cooled. The angle of the funnel flanks with respect to the opening area 35 is for example 60°.

In the representation of FIG. 1, the closure member 51 is arranged above the funnel 41. The closure member 51 comprises a for example hydraulically operated closing slide 52 which is movable back and forth between an open and a closed end position.

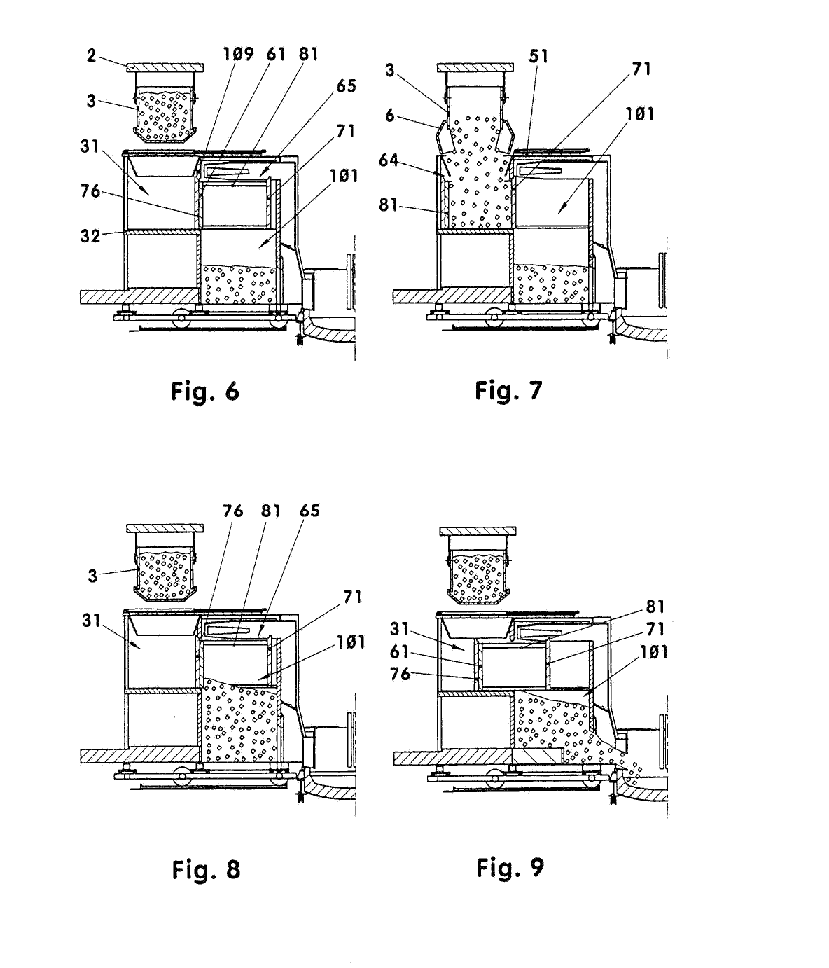

In the closed end position of the closing slide 52, the opening 35 is essentially hermetically closed. In the open end position of the closing slide 52 (see FIG. 6), the top side of the funnel is completely free. The drive of the closing slide 52 which comprises for example two hydraulic cylinders 53 arranged parallel to each other are disposed in the exemplary embodiment on the hopper-like containment 101.

It is also possible to arrange the closure member 51 between the opening 35 and the funnel 41. The closing slide 52 may then be correspondingly smaller.

In the precharging chamber 31 further a push shield 61 is arranged. This is a plate which extends in the charging hopper system 20 oriented in the transverse direction 24 and which is a reinforced plate with a thickness of for example 100 millimeter. In the representation of FIG. 1, the push shield 61 is arranged vertically. It may be provided with vertical and/or horizontal reinforcement ribs.

The push shield 61 may also be curved along a horizontal and/or vertical bending line. The bending line is disposed in each case on the push side 62 of the push shield 61 facing the separating wall 71.

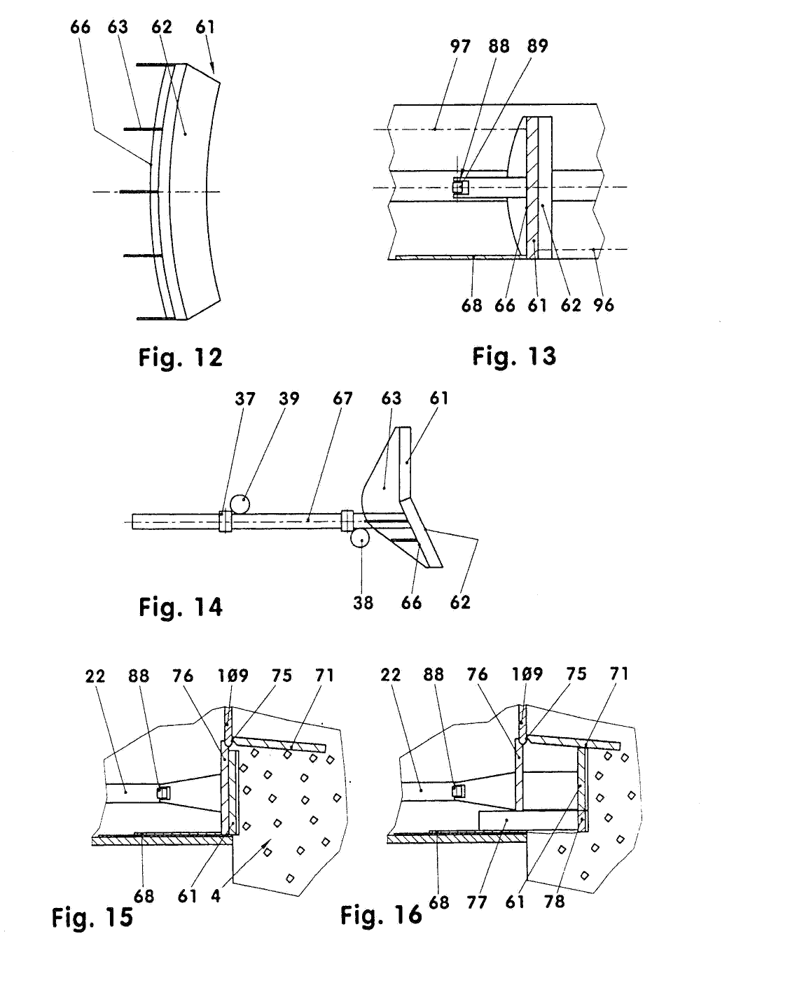

FIG. 12 shows a shovel-shaped push shield 61. It has a constant radius of curvature with a vertical bending line which corresponds to twice the width of the push shield 61. Furthermore, the push shield 61 is bent around a horizontal axis. On the backside 66 for example five vertically oriented reinforcement ribs are arranged. If appropriate additionally vertically oriented metal sheets may be arranged on the front side, for example, at the outer edges of the push shield 61. It is also possible to provide the push shield 61 in its lower area with a trapezoidal shape, a V-shape or a semi-circular shape etc.

In the start-out position 64 as shown in FIG. 1, the push shield 61 is disposed outside the vertical projection of the opening cross-section, that is, in the shadow of the funnel 41.

The push shield 61 and the separating wall 71 form in the exemplary embodiment front walls 61, 71 of a slide basket 81. For example, the six support beams 82 which interconnect the separating wall 71 and the push shield 61 have together for example a tension cross-section of at least 1000 square millimeter. The individual support beams 82 may be formed as full or hollow profiles. The side surfaces 83 of the slide basket 81 which is open at the top and at the bottom and, in the exemplary embodiment, are lined with metal sheets of a thickness of 30 millimeters. The maximum accommodation volume of the push basket 81 is in the exemplary embodiment 10% greater than the volume of the scrap metal basket 3. The upper horizontal support beams 82 may be in the form of step webs which guide the basket 81 along its path of movement.

The push shield 61 and the separating wall 71 are fased in the lower area in a transverse direction 25, see FIG. 2. In these inclined areas for example slide plates 85 are arranged on a support structure 84. In the exemplary embodiment, the push basket 81 is supported by the slide plates 85 in gravity as well as in transverse direction.

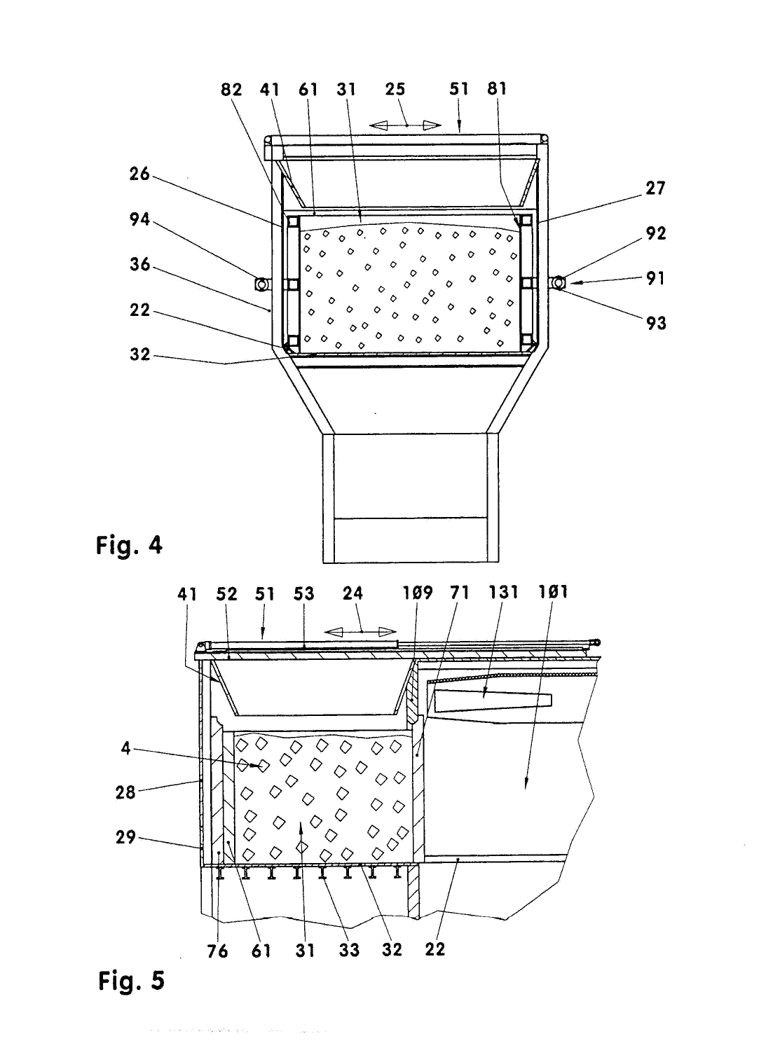

On the push shield 61, a drive unit 91 is arranged which is supported by the pre-charging chamber 31 or the hopper-like containment 101, see FIG. 4. This drive unit 91 comprises in the exemplary embodiment two cylinder-piston units 92 which are arranged at the outer side 36 of the pre-charging chamber 31 at both sides of the push shield 61. The individual cylinder-piston unit 92 has for example a water-cooled cylinder wall 93 and a piston rod 94 with a piston guided in the cylinder 93. The piston diameter is for example 300 mm, the piston rod diameter is 160 mm. The operating pressure of the cylinder-piston unit 92 is for example 160×10⁵ Pascal. The stroke of the piston is for example 5.4 m.

The hopper-like containment 101 has for example an overall volume of 200 m³ and includes in a vertical direction four areas 111-114. In all areas 111-114, the hopper-like containment 101 has an at least approximately rectangular cross-section in a horizontal plane and smooth walls 102. In the lowest area, it may be slightly conical with downwardly decreasing cross-section. The hopper-like containment 101 may be arranged in the longitudinal or in the transverse direction next to the pre-charging chamber 31.

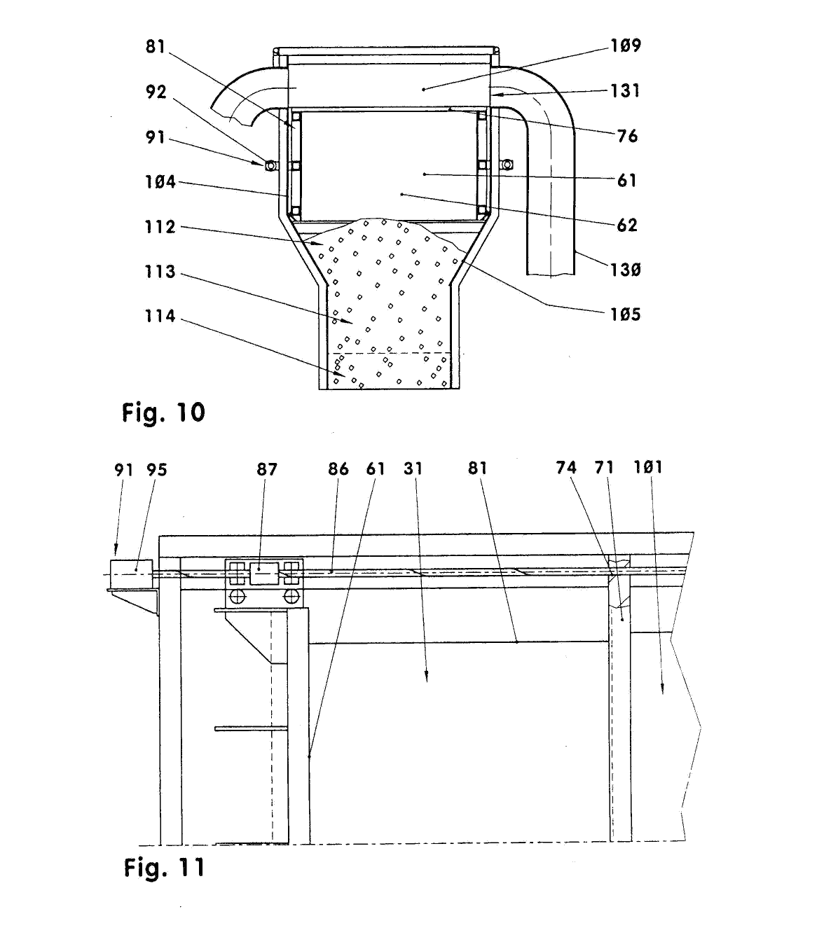

The uppermost area 111—its height is about 40% of the containment height—has at least in one of the front walls which are oriented in the transverse direction 25, a suction opening 131 for the connection of a suction line 130, see FIG. 10. This suction opening 131 has in the representation of FIG. 1 an at least approximately triangular cross-section with a cross-sectional area of for example 1.4 square meters. The cross-sectional area may also be round, rectangular, oval etc. The hopper-like containment 101 may also have several suction openings 131. The lower edge of the suction openings 131 is above the plane of the upper edge of the push shield 61.

In this uppermost area 111, the guide tracks 22 extend for example up to the uncooled wall 102 which delimits the hopper-like containment in the longitudinal direction 24. In the direction of the precharging chamber 31, this area is delimited in the representation of FIG. 1 by the separating wall 71.

In the second area 112, the cross-section of the hopper-like containment 101 becomes smaller in the transverse direction 25 along the side walls 104 from the top to the bottom, see FIG. 10. The angle formed by the containment flank 105 and a horizontal plane corresponds to the angle between the funnel flank and this plane.

The third area 113 has a constant cross-section. Its height is for example 25% of the height of the hopper-like containment 101. This area 113 may be omitted if the hopper-like containments 101 second area 112 is extended down to the lowermost area 114.

The lowermost area 114 is provided for example at the side wall 103 with a discharge opening 106. This discharge opening corresponds for example to an opening 11 of the furnace containment 10 of the electric arc furnace 5. This opening 106 is in communication for example with an opening 11 through which the scrap material is transported out of the hopper-like containment 101 into the furnace containment 10 of the electric arc furnace 5.

For the movement of the scrap material 4 in the area of the hopper-like containment 101 the charging hopper system 20 includes for example a pusher arrangement 151. By a displacement of a pusher 152 of the pusher arrangement 151, individual portions of the scrap material 4 are moved into the containment 10.

The scrap material 4 may also be moved out of the hopper-like containment 101 by gravity, by a pivot arrangement, by a vibration arrangement, by a pull drive etc.

At the side of the charging hopper system 20 facing the furnace containment 10, an exhaust gas line 141 is arranged whose upper end extends to the hopper-like containment 101. The wall of this exhaust gas line 141 consists of water-cooled pipes 142. In the exhaust gas line 141, an adjustable flap 143 is installed. This may be, as shown, a so-called butterfly flap or lamella flap.

In the exemplary embodiment, the whole charging hopper system 20 is movable. For example, the system 20 can be moved by means of a drive end and rollers 161 by a stroke length of about two meters away from the furnace containment 10. In this way, servicing work on the furnace containment 10 or the removal of the furnace containment is facilitated.

In order to charge the scrap material 4, first the filled scrap basket 3 is positioned by a building crane 2 over the closure member 51. The push shield 61 is in the start-out position 64, the separating wall 71 is closed. Upon opening the closure member 51, the scrap basket cover sheets 6 are for example hydraulically opened. The scrap metal pieces 4 fall into the precharging chamber 31 between the push shield 61 and the separating wall 71, that is, in the exemplary embodiment, into the push basket 81. After the scrap material basket 3 has been emptied, the basket 3 as well as the closure member 51 can again be closed. The charging hopper system 20 is now completely closed.

FIGS. 4 and 5 show the charging hopper system 20 after the loading of a scrap basket volume. Herein FIG. 4 shows a cross-section and FIG. 5 shows a longitudinal cross-section in the area of the precharging chamber 31. The push basket 81 accommodates the whole scrap basket volume. The closing slide 52 is closed. The separation wall 71 is centered on the hopper and seals the hopper-like containment 101 against the precharging chamber 31. The sealing wall 76 arranged at the push shield 61 has no function in this start-out position.

As soon as the level of the scrap material 4 in the hopper-like containment 101 is below a predetermined limit value, the scrap material can be moved out of the precharging chamber 31 into the hopper-like containment 101. The level may be determined for example by means weight sensors 162.

To this end, the push basket 81 is moved by means of the drive unit 31 into the front end position as shown in FIG. 6. Herewith the separating wall 71 is opened. The push shield 61 pushes the scrap material 4 along the bottom 32 until the scrap 4 falls into the hopper-like containment 101. In the front end position 65, in this exemplary embodiment, the opening 107 between the precharging chamber 101 and the hopper-like containment 101 is closed by the sealing wall 76. After the push basket 81 has been emptied, the push basket 81 can be moved again to the startout position 64. The scrap is now disposed in the hopper-like containment 101 as shown in FIG. 6. Scrap pieces which may have been left on the bottom 32 can be removed by way of discharge openings 29.

Now scrap material 4 can be moved by a pusher arrangement 151 into the furnace containment 10. With the ignition of the electrodes 12 in the scrap material 4, the melting process starts. The suctioning device draws the exhaust gases formed during the melting process through the hopper-like containment 101 into the suction opening 131. Also, part of the exhaust gases may be drawn out via the exhaust gas line 141—depending on the position of the flap 143.

The exhaust gases heated by the melting process transfer part of their energy to the scrap material 4 disposed in the hopper-like containment 101 upon flowing therethrough. The scrap is in this way preheated while, at the same time, the exhaust gases are cooled.

In the startout position 64, the push basket 81 can again be filled as described above. This is shown in FIG. 7. The separating wall 71 is again closed. Upon charging, the charging hopper system 20 therefore no exhaust gases can be released from the furnace containment 10 to the ambient 1. During filling of the precharging chamber 31, the electric arc furnace 5 can continue to melt scrap material 4 without interruption.

By means of the push arrangement 151, additional scrap material 4 is transported into the furnace containment 10 in certain intervals and the melting process is continued. As soon as the scrap 4 level in the hopper-like containment 112 is below the mentioned limit value the next content of the push basket 81 can be moved into the hopper-like containment 101 without interruption of the furnace melting process. This occurs as described above. After delivery of the second push basket volume, the scrap material 4 is disposed for example as shown in FIGS. 8 and 10. It has moved in some areas out of the push basket 81 into the hopper-like containment 101. The push basket 81 is blocked first in this position. The sealing wall 76 closes the hopper-like containment 101 with respect to the precharging chamber 31.

During further operation, the exhaust gases pass through the whole scrap column so that all of the scrap material 4 in the hopper-like containment 101 is preheated. By means of the pusher arrangement 151, additional scrap material is moved into the furnace containment 10 so that, with progressing time the height of the scrap column drops. As soon as it drops below the mentioned limit value, the push basket moves again into the startout position 64, see FIG. 9. The next filling of the basket, for example, the first basket for the next melt can then be loaded into the precharging chamber 31. After completion of the next tab, the already preheated scrap material 4 is moved into the furnace containment 10 for the next melt.

FIG. 11 shows a push basket 81 whose drive unit 91 comprises a motor 95, for example, a hydraulic motor. The guide system (22, 85) is of the same design as in the first exemplary embodiment. Parallel to the travel path of the push basket 81 a square torque steel rod for example in the form of a threaded spindle 86 is arranged. It is supported rotatably for example along the outer side 36 of the charging hopper system 20 in the longitudinal direction at both rear and front walls 28, 108 of the charging hopper system 20.

The push basket 81 has a spindle unit 87 which extends around the threaded spindle 86. The separating wall 71 has in the area of the threaded spindle 86 an opening 74 which is sealed for example by a movable disc and a labyrinth seal.

For moving the push basket 81, the threaded spindle 86 is driven by a hydraulic motor 95, which may include a gear drive. If necessary such a threaded spindle 86 with a spindle nut 87 may be arranged at each side of the push basket 81. The arrangement is operated by one or two hydraulic motors. Under certain conditions also electric motors may be used.

Another drive variant is shown in FIG. 13. The push shield 61 in this case is movable by means of two tackles 96, 97. The ropes of the tackles 96, 97 extend through the longitudinal side walls of the charging hopper system 20 and are guided on the outer wall of the charging hopper system 20 via reversing rollers and, if applicable via a pulley arrangements and/or rope drums. The latter are operated for example by an electric motor or a hydraulic motor. In the shown longitudinal cross-section, the rope tackle 96 arranged at the push side 62 is connected for example at the bottom and the rope tackle 97 at the back side 66 is connected at the top. At both sides, a guide roller 88 rolls along a guide track 22 arranged for example at an angle of 45° with respect to a horizontal plane. The guide rollers 88 have for example a roller body 89 which is supported on a shaft by friction bearings. The machined friction bearing sleeves used in the exemplary embodiment consist of a copper-tin-bronze with a lead content of for example 7%. Instead of guide rollers also slide plates 85 may be used.

It is also possible to use a single rope tackle 96, 97. Depending on the direction of rotation of the motor 95, the push shield side or the separating wall side rope section 96, 97 is then pulled and the push shield 61 is moved either into the startout position 64 or to the end position 65.

In such an embodiment, the lift protection and/or the support rollers 88 may be omitted. Instead, the rope tackle may be arranged to extend inclined upwardly or downwardly. It is also possible that the push basket 81 is supported by a tensioned rope. A centering is achieved in each case by a guide metal sheet 68, and, upon reaching the end positions 64, 65, by the separating wall 71 and the seal wall 76.

FIG. 14 shows a push shield 61 with a guide rod 67. The guide rod 67 extends for example in the direction toward the rear wall 28. At the side of the guide rod 67, for example, four guide rollers 37 are arranged whose distance from one another is greater than twice the width of the guide rod 67. Additional guide rollers are arranged in the front at the bottom 38 and in the back at the top 39 for supporting the guide rod 67. The drive of the guide shield 61 which may be reinforced by ribs 63 occurs for example by means of a piston-cylinder unit or by means of a hydraulic motor which drives the guide rod 67 via a friction wheel or a drive pinion. With a pinion drive, the guide rod 67 may for example be in the form of a gear rack.

The separating wall 71, see FIG. 15 is in this embodiment separate from the push shield 61. It is for example supported pivotally about a horizontal axis 75, on the intermediate wall 109 between the precharging chamber 31 and the hopper-like containment 101.

For moving the scrap material 4 out of the precharging chamber 31 into the hopper-like containment 101, the movable push shield 61 pushes the scrap material 4 in the direction toward the hopper-like containment 101. The scrap material pushes the separating wall 71 open which pivots in the representation of FIG. 15 then for example in a clockwise direction. As soon as the push shield 61 passes by the intermediate wall 109, the separating wall 71 is supported by the push shield 61. The sealing wall 76 carried along by the push shield 61 is pushed against the intermediate wall 109. Also, in this exemplary embodiment, the release of exhaust gases from the hopper-like containment 101 via the pre-charging chamber 31 is prevented.

During the return movement of the push shield 61, the separating wall 71 flips again into its for example vertical startout position under the influence of gravity. In this position, it seals again the precharging chamber 31 and the hopper-like containment 101 with respect to one another.

The separating wall 71 may also be independently movable and also be pivotable by a drive.

In FIG. 16, the push shield 61 and the sealing wall 76 are spaced for example by 1.5 meter. The push shield 61 can now be moved further toward the center of the hopper-like containment 101. The scrap material may in this way be leveled out in the hopper-like containment 101.

In the push shield 61 additionally an impact structure 77 may be arranged. This impact structure 77 may for example be of the same design as the push arrangement 151 of the charging hopper system 20. The impact shield 78 of this impact structure 77 can move relative to the push shield 61. Herein, the push shield is in the shown basic position in alignment with the push side 62 of the push shield 61. From this position, it may be moved for example by one meter in the direction toward the center of the hopper-like containment 101. The width of the impact shield 78 may correspond to the width of the push shield 61 or it may be smaller than the push shield 61. The impact shield 78 may comprise separate segments.

Also combinations of the various exemplary embodiments are possible.

Listing of Reference Numerals

| | |
|---|---|
| 1 | Ambient |
| 2 | Transport arrangement, building crane |
| 3 | Scrap metal basket |
| 4 | Scrap material |
| 5 | Electric arc furnace |
| 6 | Scrap basket cover sheets |
| 10 | Furnace containment |
| 11 | Opening |
| 12 | Electrodes |
| 20 | Charging hopper system |
| 21 | Support furnace |
| 22 | Prism webs, guide tracks |
| 23 | Guide surfaces |
| 24 | Longitudinal direction |
| 25 | Transverse direction |
| 26 | Side walls |
| 27 | Side walls |
| 28 | Rear wall |
| 29 | Discharge opening |
| 31 | Precharging chamber |
| 32 | Bottom |
| 33 | Beams |
| 34 | Top side |
| 35 | Opening |
| 36 | Outer side |
| 37 | Guide roller |
| 38 | Front guide roller, bottom |
| 39 | Rear guide roller |
| 41 | Sealed funnel |
| 42 | Funnel flank |
| 51 | Closure member |
| 52 | Closing slide |
| 53 | Hydraulic cylinder - piston unit |
| 61 | Push shield |
| 62 | Push side |
| 63 | Reinforcement ribs |
| 64 | Startout position |
| 65 | End position |
| 66 | Back side |
| 67 | Guide rod |
| 68 | Guide metal sheet |
| 71 | Separating wall |
| 72 | Top side |
| 73 | Centering fases |
| 74 | Opening |
| 75 | Horizontal axis |
| 76 | Sealing wall |
| 77 | Impact structure |
| 78 | Impact shield |
| 81 | Push basket |
| 82 | Support beams |
| 83 | Side surfaces |
| 84 | Support structure |
| 85 | Slide plates |
| 86 | Threaded spindle |
| 87 | Spindle nut |
| 88 | Guide roller |
| 89 | Roller body |
| 91 | Drive unit |
| 92 | Cylinder-piston unit |
| 93 | Cylinder |
| 94 | Piston rod |
| 95 | Hydraulic motor |
| 96 | Tackle |
| 97 | Tackle |
| 101 | Hopper-like containment |
| 102 | Walls |
| 103 | Un-cooled side wall |
| 104 | Side wall |
| 105 | Containment flank |
| 106 | Discharge opening |
| 107 | Opening |
| 108 | Front wall |
| 109 | Intermediate wall |
| 111 | Uppermost area |
| 112 | Second area |
| 113 | Third area |
| 114 | Lowermost area |
| 130 | Suction line |
| 131 | Suction opening |
| 141 | Exhaust gas line |
| 142 | Water-cooled pipes |
| 143 | Flap |
| 151 | Pusher arrangement |
| 152 | Pusher |
| 161 | Rollers |
| 162 | Weight sensor |

What is claimed is:

1. A charging hopper system (20) of an electric arc furnace (5) with a closure member (51) which can be opened, a hopper-like containment (101), a discharge opening (106) and with at least one suction opening (131), comprising
a precharging chamber (31) with a closure member (51,
the precharging chamber (31) being separated from the hopper-like containment (101) by means of a separating wall (71), which can be opened, and
a movable push shield (61) arranged in the precharging chamber (31).

2. The charging hopper system according to claim 1, wherein the push shield (61) has a shovel-like shape.

3. The charging hopper system according to claim 1, wherein the precharging chamber (31) is provided at its top with a filling funnel (41).

4. The charging hopper system according to claim 1, wherein the projection area of the separating wall (71) onto the plane of the separating area is greater than the area of the push shield projected onto the same plane.

5. The charging hopper system according to claim 1, wherein the push shield (61) and the separating wall (71) form the front walls of a push basket (81).

6. The charging hopper system according to claim 5, wherein the push basket (81) has no bottom.

7. A method for filling a hopper-like containment (101) of a charging hopper system (20) according to claim 1,
wherein, with the push shield (61) disposed in a start-out position (64) and the separating wall (71) closed, the closure member (51) is opened,
wherein after loading of the scrap material (4) into the precharging chamber (31), the closure member (51) is closed, and
after the separating wall (71) is opened, the push shield (61) moves the scrap material (4) into the hopper-like containment (101).
